(19) United States
(12) Patent Application Publication
(10) Pub. No.: US 2008/0262917 A1
(43) Pub. Date: Oct. 23, 2008

(54) Internet advertising impression-based auction exchange system

(76) Inventors: Jeff Green, Ventura, CA (US); William Urschel, Seattle, WA (US)

Correspondence Address: MARK RODGERS, 1590 SAN ROQUE ROAD, SANTA BARBARA, CA, 93105, US

(21) Appl. No.: 11/788,111

(22) Filed: Apr. 19, 2007

(51) Int. Cl. G06Q 30/00

(52) U.S. Cl. 705/14

(57) ABSTRACT

The invention is a neutral, real-timed impression-based, auction internet advertising exchange. On the novel exchange, advertisers and web site publishers interact through a broker who communicates directly with the Exchange. Advertisers specify bids to their brokers who enter them in the Exchange. Publishers may specify minimums or a form of payment to their Brokers who enter them into the Exchange. When a site from a publisher that is brokered on the Exchange is accessed by a user, a real time auction is held on the Exchange. During the auction, which preferably happens within 100 msec, information about the site and the user is communicated to the brokers. The brokers consult the strategies for their advertisers to determine a bid, based on the information from the Exchange, to place ads on the site. (This makes it seem like the brokers target and bid during the exchange rather than in advance.) The highest bid, or bids for multiple ad spots on a site, results in corresponding ads placed on the site. The exchange supports flexible payment bases as well as providing significant feedback to brokers, allowing for much more effective internet advertising campaigns.

### RELATED APPLICATIONS

Not Applicable

### FEDERALLY SPONSORED RESEARCH

Not Applicable SEQUENCE LISTING

Not Applicable

### BACKGROUND OF THE INVENTION

The invention relates to Internet Advertising, and in particular a novel exchange which typically results in more cost-effective results for online advertisers and more revenue for website publishers.

In most advertising systems, an advertiser cannot target a unique message to each individual recipient. If an advertiser buys a billboard space on a busy highway, many people will see his ad, but only a small percentage of viewers are potential buyers. The advertiser's best hope for success is to make assumptions, perform analysis, and draw conclusions of the areas surrounding the busy highway and target accordingly. Television and magazines have similar limitations. Advertisers cannot personalize the message depending on the demographic or behavioral attributes of each individual viewer. The classic advertising scenario is depicted in FIG. 1. As shown in the figure, there is typically at best a small overlap between the audience the advertiser wishes to reach, and the actual audience he reaches (and pays to reach). Also in television, magazines, and billboards, the pricing is usually inefficiently based on a rate card or price sheet, resulting in a cost structure that does not vary with the degree of overlap between desired audience and actual audience. The Internet provides a unique opportunity to change both the targeting and pricing limitations of advertising.

Most Internet advertising networks and companies dealing in Internet advertising still use a rate card and usually offer only a few methods for advertisers to target website users. However, the possibility exists to more directly target advertising at users and allow advertisers to specify any price, rather than using a rate card. To date the connection between users, site publishers and advertisers does not use the resources available to make the most of targeting information and effective pricing methodologies.

This invention substantially improves the effectiveness of advertising by simultaneously achieving two beneficial results: decreasing ineffective expenses for advertisers and increasing revenues for publishers. The object of the invention is to give advertisers new levels of control on pricing and more targeting methods from a virtually comprehensive list of options and detailed, up-to-the-minute reporting results, creating a truly novel Internet advertising exchange.

### BRIEF SUMMARY OF THE INVENTION

In one embodiment, the invention is an Internet Advertising process for matching advertisers with publishers via their respective brokers. The matching process includes providing an exchange (on which the brokers represent the advertisers and publishers) and holding a real time auction on the exchange when a publisher's site is accessed by a user. Advertisers specify their bids and targets to the exchange, via the broker, in advance. The exchange determines if the ad available and the user are appropriately matched with the bids offered and targets specified.

In particular versions, advertiser targeting strategy and correlating bid price is based on information about the user and/or publisher site, which is considered in behalf of the broker by the exchange at the time the site is accessed. The information includes one or more of following categories of targeting; contextual targeting,

behavioral targeting,
demographic targeting,
technology targeting,
time and space targeting,
those categories of targeting include but are not limited to:
advertiser frequency caps,
publisher caps,
user time zone,
specific time zone,
country, State, city, DMA
site content ratings,
site animation,
site format,
other site specific data,
user browser type,
user operating system; or,
ad type,
age,
gender,
income,
channel,
category,
keyword,
mobile,
desktop app.

The auction is run for every single impression. The impression is the most granular unit of Internet advertising. Preferably, the auction is held within 100 msec, and usually much lower.

In other versions of the invention, the exchange supports brokers accepting advertiser payments and paying publishers based on differing valuation basis. The valuation basis supported by the exchange include;

CPM (cost per thousand),
CPC (cost per click),
CPL (cost per lead), or
CPA (cost per action or cost per acquisition).

### BRIEF DESCRIPTION OF THE DRAWINGS

The invention will be better understood by referring to the following figures.

FIG. 1 illustrates the discrepancy between users actually reached and user desired to be reached in traditional advertising.

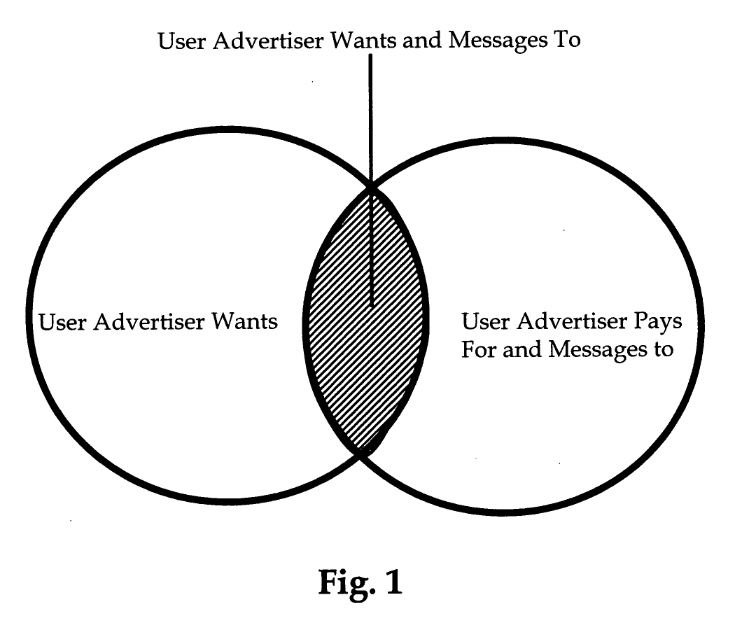

FIG. 2 shows the relationship between the various participants in the exchange.

FIG. 3 is a flow chart showing the steps in an ad placement transaction.

FIG. 4 is a more detailed flow chart showing the operation of the exchange.

FIG. 5 illustrates how revenue is apportioned in the exchange

FIG. 6 shows a version of the apportionment when the transaction is private within one member's network

FIG. 7 shows the type of information available to generate an advertising strategy on the exchange.

FIG. 8 shows how the pricing structure available on the exchange is advantageous.

### DETAILED DESCRIPTION OF THE INVENTION

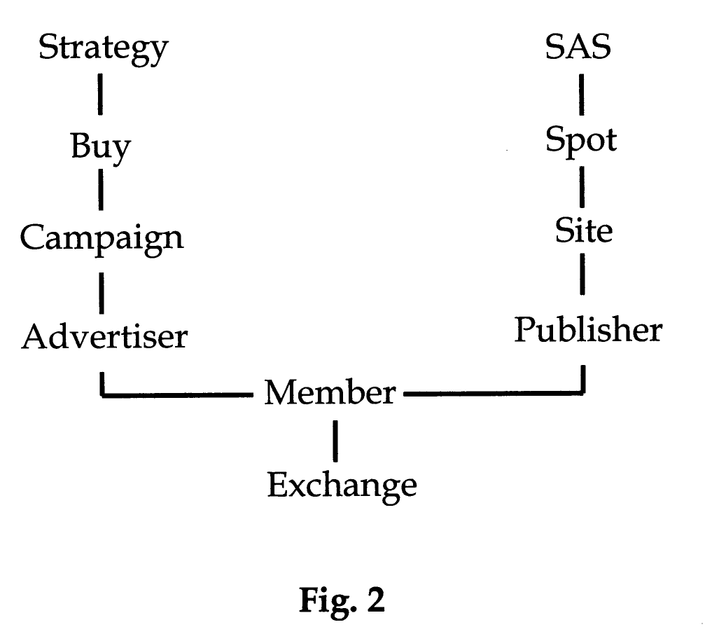

The invention is a real-time, auction-based exchange for online display advertising in which a member of the exchange (usually an advertising network, broker, or agency) buys on the exchange for its advertisers and sells on the exchange for its web site publishers. Generally, the novel exchange represents a highly organized and sophisticated secondary market. Like any advanced marketplace, the exchange and its operators do not participate directly in the marketplace; they create and protect the marketplace. The exchange itself only benefits from transactions on a flat fee basis, so it doesn't benefit from the value of transactions (or by click fraud as some large Internet players do currently). Its goal is to provide brokers a fair opportunity to exchange advertising. The exchange allows the market (AKA: the members and the exchange participants) to dictate pricing according to perceived supply and demand. The exchange only regulates and provides detailed information to both buyers and sellers to make sure that the buyer is aware, which results in buyers and sellers having the ability to assign value based on all critically relevant information. The exchange also functions as the clearing house between members, so the members never have to worry about credit risk or collection. The exchange is operated on an impression basis (every time an ad appears). This allows participants to change and determine value for the unique attributes of every single ad request. This uniquely granular approach provides each member of the exchange and their clients the necessary control to uphold this sophisticated, novel exchange. The relationship between the participants is illustrated in FIG. 2. As shown in FIG. 2 the exchange's clients are members, operating as brokers. The members have advertisers, which are almost always product owners or their agents, who are buying advertising space in accordance with a strategy. And members also have publishers, which are almost always site owners or their agents, who are selling advertising space, or spots, on their websites. The publisher's web sites will most likely have ads placed in various places throughout the site. Preferably, the designated area will show various ads that are all the same initial size. The publisher will place a snippet of code (defined herein as an ad spot) in his web site code for each location on the site he'd like it to appear. That snippet of code only need be unique for each format (ads of certain pixel dimensions), but it may be unique for every location.

An exchange member's client, a publisher, may have 1000 web pages on a single web site. He may place a particular spot (code snippet) for the banner format at the top of every page. Thus he would have one ad spot in 1000 different locations. However, the system can track those 1000 different locations (each referred to as a SAS) whenever the URL of that page's content is available. The referring URL of the referring URL may be used in cases of frames or iframes. This level of granularity in publisher inventory in conjunction with running an auction for every ad impression provides members with unprecedented levels of control. Simply put, a publisher has spots available for advertising on a site, which advertisers compete to obtain. In the novel exchange, the competition takes place in a real-time auction in response to an Internet user accessing the exchange via a publisher's spot on a publisher's site. The member's advertisers specify in advance how much they are willing to pay based on a user's profile, or the user's past behavior, or the page content, or other factors. Advertisers can bid on a CPM, CPC, CPA, or CPL basis. When a user lands on a website page, an auction is held among all the advertisers—preferably in less than 100 milliseconds, for every single ad impression. The highest bid for a particular spot wins, and that ad is shown in the spot.

In order to keep the market fair, balanced, and open, the market provides its members flexibility. Members may possibly allow all, some, or even none of their traffic requests to participate on the exchange or instead just use the exchange technology to match their advertisers with their own publishers. Usually, the members specify that the auction favor a match between their own publishers and advertisers, unless the profit of using traffic from the Exchange exceeds a certain threshold. This guarantees members the best possible liquidity—fewer ad campaigns go unfilled, less inventory goes unsold, and members make the highest profit, always.

The Exchange serves its members (i.e. brokers with seats on the exchange), who in turn serve their advertisers and publishers. Advertisers and publishers typically do not deal directly with the Exchange, they work through a member. The member's advertisers and publishers need not even be aware that their advertising network or broker is trading on the Exchange.

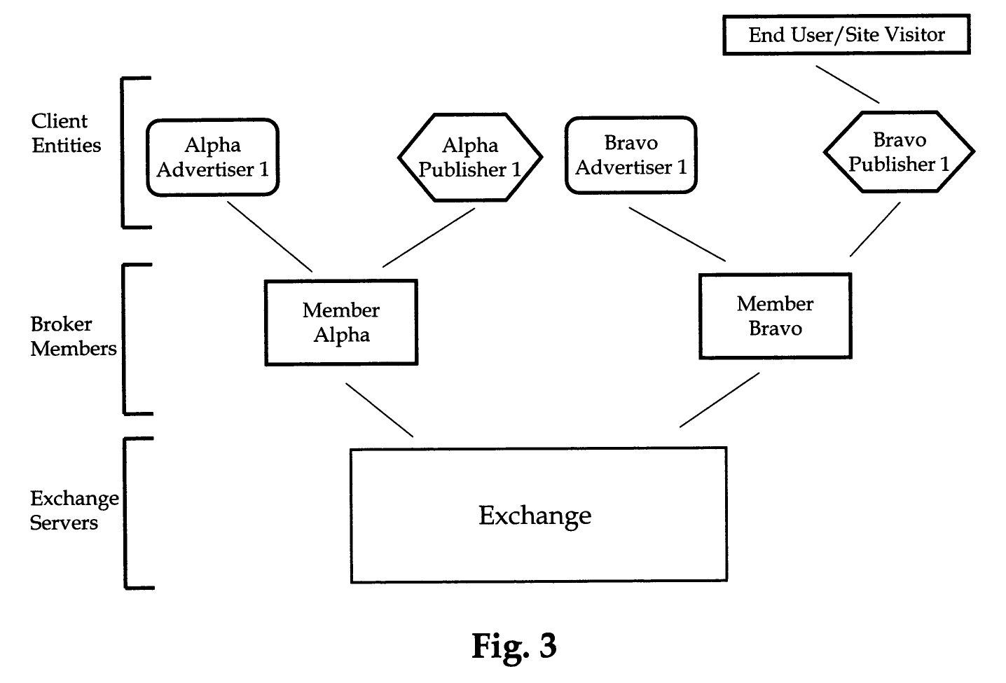

As shown in FIG. 3 the Exchange is the central marketplace operating at the server level. The member is the advertising network or advertising broker that holds a seat on the exchange and acts on behalf of the broker's clients, the advertiser or publisher, in executing transactions. There are many seats on the exchange, and each member has its own advertisers and publishers. End users are the site visitors from the web (www) that the advertisers wish to reach by placing ads on the publisher's sites.

On the advertiser side of FIG. 2:
The advertiser is the entity paying a member to run ads. Advertisers are usually product owners or their agents. A member can have any number of advertisers.
A campaign is a general advertising effort of an advertiser, and may be focused on a specific product line. An advertiser can have any number of campaigns.
A buy is the budgeting and scheduling level of the campaign structure. The buy controls how much money is spent and when it is spent. A campaign can have any number of buys.
A strategy is the targeting and bidding level of the campaign structure. The strategy level is also where the creatives (the ads themselves) are assigned and grouped. A buy can have any number of strategies, and any number of creatives.

On the publisher side of FIG. 2:
The publisher is the entity that owns the website that accepts advertisements.
The site is the actual website where the spots are defined. A publisher can have any number of websites.
The ad spot is the snippet of code on a website page where an ad can appear. It is typically created by the publisher (using the exchange interface) and then is placed in at least one location on one page on one of the publisher's sites. The ad code specifies the format (size), acceptable content, and other parameters. A spot is always a subset of the site, and there can be any number of spots on a site.
The SAS is the specific location on a website page where an ad can appear. It is typically defined by the ad code created by the publisher (within the exchange interface) and placed at that location. The ad code specifies the format (size), acceptable content, and other parameters. A SAS is always a subset of the spot, and there can be any number of SAS in an ad spot.

A possible transaction on the Exchange is illustrated in FIG. 3. There are three levels of participation in the exchange. The exchange server level is the exchange itself. Brokers are the members of the exchange, and only members communicate with the exchange directly. The inventors have a working exchange, (AdECN) which is used herein to illustrate the novel exchange. The clients are the advertisers and publishers who communicate with the brokers. Publishers, using their member's Exchange interface, place their ad spot inventory in the exchange. Advertisers, using their member's Exchange interface, specify in advance the targeting they want and how much they are willing to pay. In the figure, an end user/site visitor lands on a website page owned by a publisher in Member Bravo's network. The publisher's spot on the publisher's site contains ad code which makes an ad call to the AdECN exchange when the visitor's browser executes a page. This triggers a single-pass auction among all of the interested advertisers within the AdECN exchange from both the publishing member's advertisers (the private network) and all other qualified members. The auction preferably takes less than 100 milliseconds. In every transaction, the exchange determines the bid within the private network (in which the member supplies both the advertiser and publisher) that benefits the publishing member most according to price and the bidder from all of the other members of the exchange (in which the member only supplies either the advertiser or the publisher) that benefits the publishing member most according to price. Then before declaring only one bidder the winner, the preferences of the publishing member are examined, and the transaction that benefits that member most, according to his setting (which could be price or something else), is declared winner.

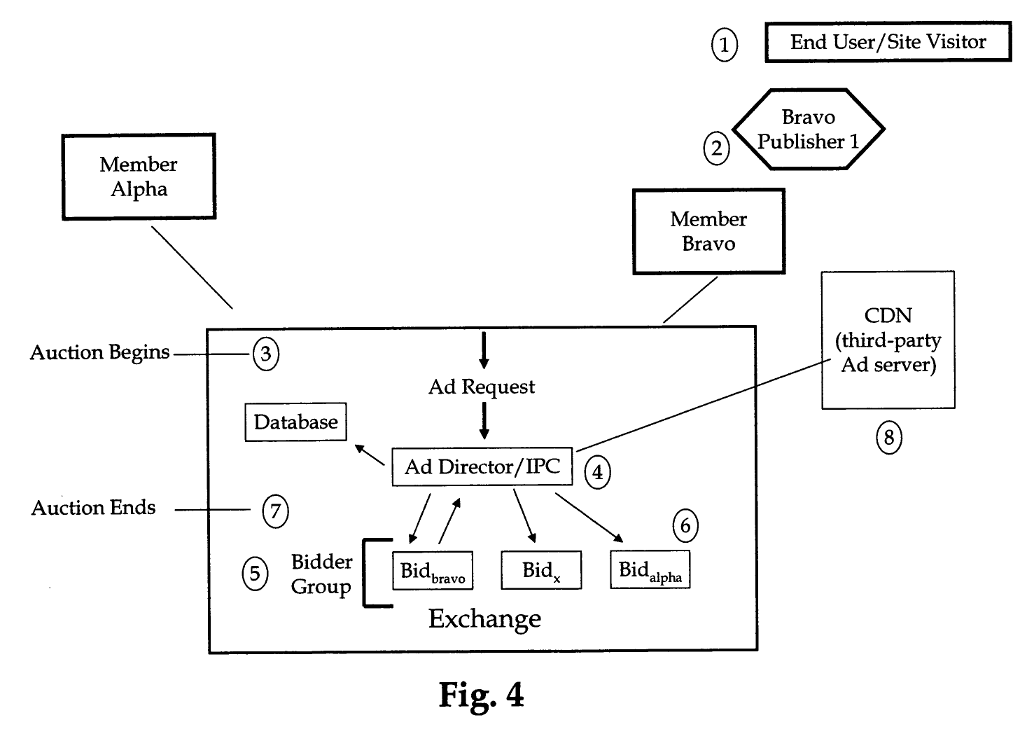

In FIG. 4, the flow of a single transaction is illustrated:

A. A visitor lands on a specific page on a specific website which Bravo publisher represents at (point 1 in FIG. 4).
B. A request is made to Bravo publisher to deliver content. (point 2)
C. Bravo publisher requests AdECN to return an AdECN ad if the minimum CPM is met or exceeded. (point 3) In the request all needed cookie data from the AdECN cookie is passed with the request.
D. The ad director server group immediately references all AdECN cookie data with additional correlated data from RAM about the viewer and/or the page the viewer has just accessed. That RAM and storage may be in a group of machines dedicate to providing the data, Information Provider Cache Group (IPCs). The ad director may also filter out which bidders it would like to hear from in the auction (point 4). The ad director then opens the auction for bidding and sends a multicast message, including all of the auction information for this auction (point 3) which includes user information and site information, to the selected bidder server groups (point 5).
E. The bidder server group responds to the ad director server group with all bids from advertisers bidding with qualified criteria (point 6). Bids may come from Member bravo, alpha up to member N, basically any interested member of the exchange.
F. The ad director group declares a winner (point 7) according to the publishing members preset values. Then, depending on the advertiser's creative's settings, AdECN sends a request to either the AdECN provided ad serving option (which may include) a content distribution network (CDN) (point 8) or a third-party ad server to serve the ad, and then logs the winning advertiser's information, the publisher's information (include site, spot, context, and time) for the given impression, and all known user information. This transaction occurs for every single impression in the network.

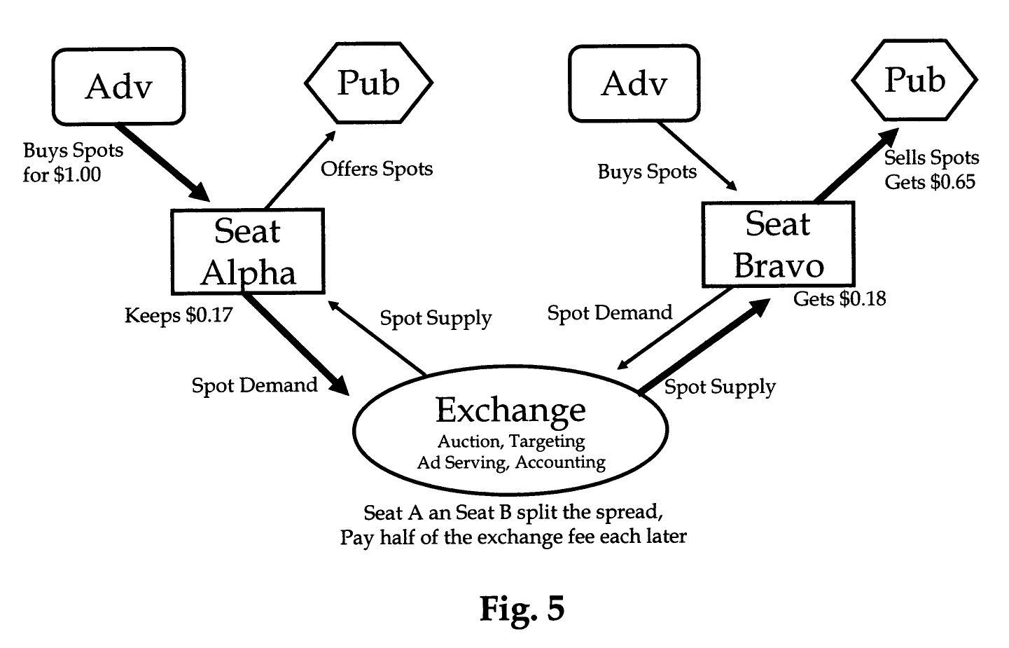

FIG. 5 outlines an executed transaction. However prior to the exchange running any transactions the participating members must have completed the following:

1. Seat Holder/Member Bravo signed up as a member in the novel exchange. As a part of sign-up they made specifications, including the definition of the highest bidder. The highest bidder may be the bidder which results in the highest payment to the member or, according to the publisher settings; it may be the bidder that results in the highest payment to Bravo Publisher 1.
2. The bravo advertiser 1 made his bid for all of his targeting strategies in advance. He placed his bid using the user interface provided by member Bravo, which interface may be provided by AdECN. The UI accesses and updates the AdECN database. The AdECN database updates the bidder server group upon change.
3. The Bravo publisher adds AdECN ad code to his website such that web requests are made when an end-user/site visitor lands on a page, an AdECN request is made. The publisher also specifies his default category and the minimum CPM he's willing to accept for any given impression on that spot.

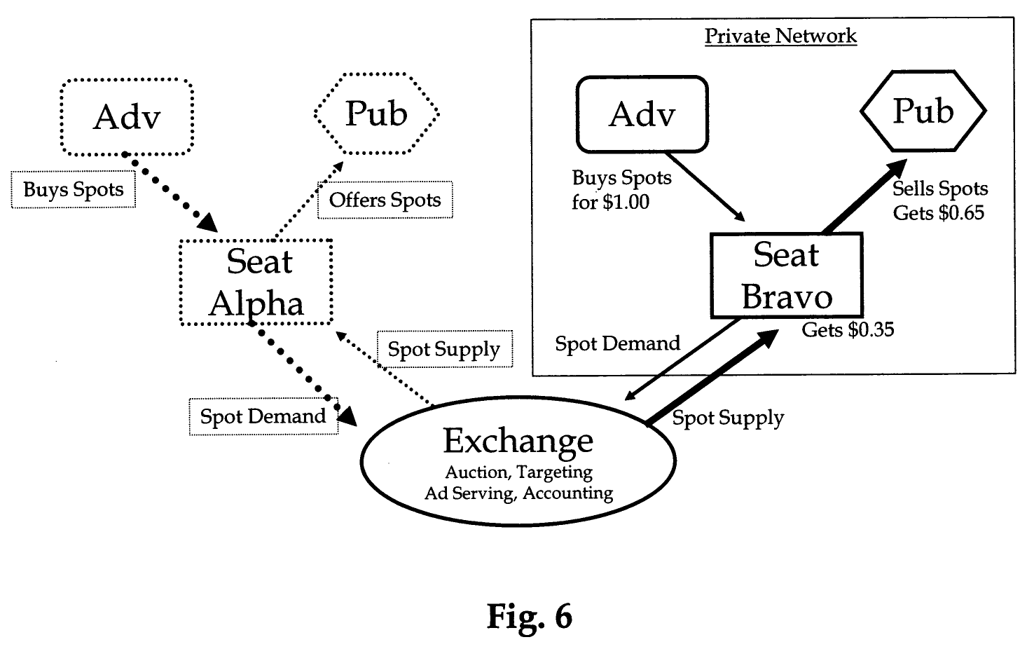

In FIG. 5, the flow of a single transaction is illustrated. The user visited Seat Bravo's publisher, which triggered the auction. The auction was run and advertiser bidding the amount that benefited Seat Bravo the most was Alpha's advertiser. The advertiser paid $1.00 CPM for the impression. The two members took the margin percentages that they predetermined and set (in each case the members used the system default setting of an 18% margin on the publishing members account and 17% margin on the advertising members), which means the publisher received the remaining $0.65. The exchange preferably tracks all useful details of every auction, provides complete accounting to its members, and handles collections and payments from the members to the Exchange. Members could have specified the following exchange participation settings which could alter the supply and/or demand for each impression and adjust the mechanics of auction:
Keep this site private. This selection is made by a member acting as the publishing member. This requires the exchange to hold a private auction for the member's own advertisers on this particular site in order to keep the transactions on this site only private within the Bravo network.
Keep all of my sites private. None of the other members' advertisers will be allowed to bid on an impression from any of the member's publishers.
Keep all of my sites and all of my advertisers private. This requires the exchange to exclude all other members from bidding or accepting bids from the member. This means this member has created an exclusive economy (see FIG. 6—private network).
Keep this advertiser private. This selection is made by a member acting as the advertising member. This requires the exchange only permit this specific advertiser to bid on impressions the member's publishers make available. The advertiser will never bid on an impression from a publisher provided from another member.
Keep all of my advertisers private. None of the member's advertisers will ever bid on an impression from any publishers provided from other members.
Other arrangements can be supported as well.
   A primary benefit to members of the Exchange is liquidity: fewer campaigns go unfilled, and less inventory goes unsold. At a macro level, since all parties (advertisers, publishers, and brokers) involved are more efficient than current models commonly allow, The market prospers and produces more value, and ultimately end-users are more satisfied because they see more relevance and value in the ads they are shown.

While staying neutral, the Exchange supports methods to generate revenue for itself as well. A member preferably must buy his seat on the Exchange. This can be a one-time, upfront payment that will cover the cost of the additional hardware and interface customization needed to serve the member. The cost of the seat can vary, based on the member's projected volume and quality of its traffic. The Exchange can also charge all members a small transaction fee for every auction it runs. The inventors have found a transaction fee varying from under $0.0005 CPM to $0.15 CPM based on the volume of transactions from the member is sustainable. If one member provides the buyer and another member provides the seller, the fee can be split between the two members. If a single member provides both the buyer and the seller, that member pays twice the fee. The Exchange preferably should not participate on a percentage or revenue share basis in the transaction, because it advantageously should remain a disinterested, neutral marketplace for its members.

This novel exchange also creates novel sub exchange for information and user data. Is step D mentioned in section 0018, information providers can provide data to the exchange that can be used by advertisers on demand.

The novel exchange can partner with any company that has user data available. It can be the recent search history or other internet behavioral data. It can also be information about the user, such as demographic information. The provider such as a free email service, social network, merchant, or credit bureau could simply place a secure pixel on their system for the user's login page. In that pixel they pass to AdECN only the profile, no personally identifiable information such as name or social security number are allowed to be passed to AdECN. By only requesting the profile, the user's privacy is protected. AdECN then id's a user with a cookie containing a user number, and that number is passed in the ad call and so that the ad director can use that number to reference the profile from the IPCs.

In advance, AdECN creates an agreement with information providers for a specific revenue share. For instance, AdECN agrees to pay the information provider 20% of the winning bids for all auctions that use the personal data. Then, an Advertiser A specifies in advance of any given auction that he'd like to target his ad exclusively to a specific demographic or behavioral group, say 34 year-old females. When the auction is run, in the AdECN system, the ad director requests all information available for this site and user for this impression from the IPC group. The auction multi-cast then sent to the bidders contains all available user data. In this case, Advertiser A will only bid on auctions in which it is known the user is both 34 and female.

In this sub market, there is economic pressure on the information providers to move prices downward because if the same information is available from two or more information providers the system will only use and pay for the data that is least expensive. For instance, using our example, if two information providers had made available to the exchange that a particular user was a 34 year-old female and one provider required a 25% revenue share and the other required a 15% revenue share then the novel exchange would only use the data from the provider with the 15% revenue share.

In this sub market there may be instances when two or more information providers are required to fulfill a given bid on a given impression. For instance, there may be one information provider that provides that a given user is female, but another information provider may provide that the same user is 34 years old. In that case, all of the available information is made available in the auction for bidding, but each information providers whose information is used in the winning bid will get their revenue percentage divided by the number of information providers. For example, in an auction where the winning bid required the uses of data, and one provider contracted at a revenue share of 15% supplies the age of 34 and another information provider contracted at a rate of 25% supplies the gender. The first information provider would receive 15%/2 and the other information provider would receive 25%/2, essentially 12.5%.

The exchange also improves the collection process for advertisers and publishers. Currently, when publishers sell ad space through brokers, the publisher generally doesn't get paid until the advertiser pays the broker. Dealing only through members and instituting a regular billing/disbursement cycle, Bills are sent and invoices paid by the exchange. Since the exchange has leverage on the advertiser side, the collection process works smoothly and predictably.

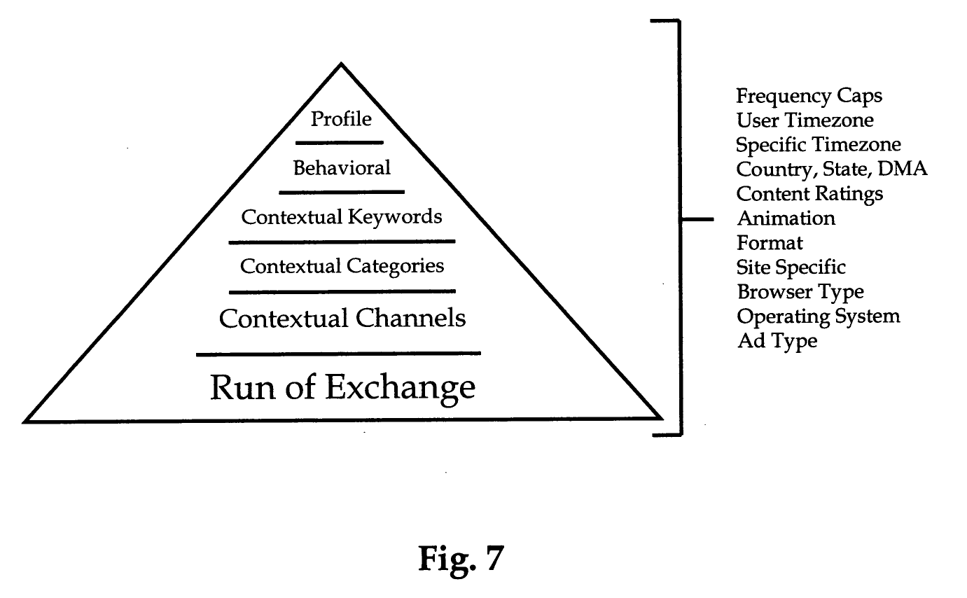

An important element in the Exchange based market place is the advertiser campaign. The Exchange uniquely takes advantage of the capabilities the Internet can provide to achieve targeted advertising. The inventors have offered the following capabilities on the Exchange for advertisers:
Create one or more advertising campaigns. It is at the campaign level that an advertiser can exclude specific publishers or websites.
Create at least one buy for each campaign. A buy is where the advertiser can allocate budget dollars and define start and end dates.
Create one or more “strategies” for each buy. A strategy is where the advertiser defines the matching criteria he wants.
To each strategy they assign one or more ads, referred to as a “creative” or “creatives”. They can have any number of strategies for a buy.
Turn on a campaign and “go live,” and then watch their results in real-time, fine-tuning their strategies as needed.
   Targeting is a particularly useful tool that takes advantage of the information (cookie) passed to a site about a user when the user clicks on the site. Examples of the kind of targeting capabilities that can be used are shown in FIG. 7. Advertisers can specify in advance just what sort of advertising opportunity they want. The matching strategies they can use include the following targeting categories:
   Contextual—advertisers target based on the context of the html content of the web page where the ad may be shown. There are at least four levels of contextual relevance, including specific website, channels, a variety of categories, and by any number of keywords. The Exchange preferably reads the website page on the fly to determine the true content—easily keeping up with ever-changing blogs and news sites.
   Behavioral—advertisers target based on the web site visitor's recent behavior or web activity. For example, advertisers can select viewers based on the viewer's recent search engine queries and enter words or phrases to match.
   Demographic—advertisers target based on the demographic information of the user, such as age, gender, income, and geography.
   Technology—advertisers target based on the technology use and preferences of the viewer. For example, advertisers can select viewers based on their browsers (examples: Firefox, Internet Explorer, Mozilla, Opera, and/or Safari) and/or their operating systems (examples: Microsoft Windows, Mac, BSD, Linux, or Sun).
   Time and space—advertisers target based on the geographic location and time of day of the viewer or advertiser. Frequency-capping also prevents any one viewer from seeing any one ad too many times in a day.
   The Exchange is developed with modular targeting capabilities, so individual targeting methods can constantly be added under the categories of targeting. The individual targeting methods include but are not limited to:
   Advertiser frequency caps—is control performed by advertiser or member which limits the number of times that any single user can view any certain buy within a certain period. For example a 2 per 24 cap means that the advertiser will only show the ad 2 times per user per 24 hours;
   Publisher caps—is a control performed by the publisher or publishing member which limits the number of times a user can receive any ads from a specified spot. For example a 1 per 24 cap means that a spot will only show 1 ad per 24 hours;
   User time zone—advertisers control if a buy runs according to the end-users time zone. For example, advertiser targeting business-to-business products 9:00 am to 4:00 pm will show the ad to a user in London at 9:00 am to 4:00 pm GMT and likewise a user in Los Angeles at 9:00 am to 4:00 pm PST;
   Specific time zone—advertisers control if a buy runs according to the advertisers specified time zone. For example, an advertiser requesting end-users to respond to a call center that only has operators standing by in New York City from 9:00 am to 4:00 pm. The ad will show to users in New York City from 9:00 am to 4:00 pm EST and likewise a user in Los Angeles at 6:00 am to 1:00 pm PST;
   Country, State, city, or DMA—advertisers control which area's end-users are eligible to view the ad based on the current IP address of the user;
   Advertiser content ratings—publishers can exclude ads based on ratings such as Language, Nudity, Violence, Animation, Alcohol, Audio, Dating/Romance, Expandable, Gambling, Guns, Network, Political, Sex/Diet Drugs, Tobacco, and/or Video which can be determined by the advertiser, member, or in some cases by the system;
   Site content ratings—advertisers can exclude their ads from appearing on sites that contain certain content based criteria such as Language, Nudity, Violence, Animation, Alcohol, Audio, Dating/Romance, Expandable, Gambling, Guns, Network, Political, Sex/Diet Drugs, Tobacco, and/or Video;
   Site format—advertisers' ads must specify in advance the dimensions of each ad. Publishers will create spots with specific dimensions and only ads of matching dimensions will appear on those sites;
   Rich media—advertisers can target and broadcast Point Roll and Eyeblaster and similar interstitial creatives to spots which publishers have specified and permitted to receive rich media ads;

### Other Site Specific Data;

User browser type—advertisers can target ads according to the browser the end-users use to view the ads;
user operating system—the advertiser can target ads to users based upon which type of operating system they are using at the time of viewing the ads. For example, advertisers can target users using Windows 98 or Windows XP or OSX.
ad type—the advertiser can target the medium the publisher uses to publish the ad. For example, the advertiser can target a standard web browser, a desktop application, or mobile device.
age—advertisers can target the age of the specific user viewing the ad.
Gender—advertisers can target the gender of the specific user viewing the ad.
income—advertisers can target the income of the specific user viewing the ad.
channel—the advertisers can specify that ads will only show on web sites that fall within a certain channel. All websites are divided into approximately 27 channels. For example, an advertiser may specify that he will only show his ad within web pages that are related to sports and recreation.
categories—the advertisers can specify that ads will only show on web sites that fall within a certain subset of the channels. All websites are divided into approximately 255 categories. For example, an advertiser may specify that he will only show his ad within web pages that are related to sports & recreation: football.
Keyword—advertisers can specify that ads will only show on web sites that contain a certain keyword or group of keywords. For example, the advertiser can specify that the ads will only show on pages containing the keyword of “mortgage” and “refinance”.

As described above, the targeting allows the advertiser to buy a single view or an impression, which is matched to the person or the specific content or circumstance of that impression: the context of the page, the past behavior of the viewer, the profile of the viewer, the geographic location of the viewer, the time of day, the number of times the viewer has already seen the ad, and so on and on. The advertiser can specify the impression he wants, and at the same time specify (bid) what it is worth to him. When it gets that impression, he knows what he got, and he knows that he did not overpay.

The exchange also introduces a novel way of conducting contextual reads of the page. The novel exchange has created a contextual tool that is built around internet interests and on a point system rather than just a dictionary-like taxonomy.

Another novel capability the Exchange system can offer is a guarantee that an advertiser will not overpay for under-performing inventory. The Exchange can contain an application that tracks the performance of every single ad spot—every location for every ad on every page on every site in the Exchange. Just before an auction, this application can check the history of the spot. If the spot performs about as well as other spots in its category, the advertiser's bid is made. However, if the spot under-performs its peers, the advertiser's bid is reduced accordingly, to reflect the relative value of that spot.

The Exchange further offers flexibility in revenue generation for all parties as well as risk reduction. A broker can make an additional profit by letting his advertisers pay on one basis, but paying his publishers on another. This is called “arbitrage.”

Many advertisers pay on a CPM (cost per thousand) basis, where they simply pay a certain amount for every thousand impressions. Publishers are almost always paid on a CPM basis. But some advertisers prefer to shift the risk from themselves to the publisher or the Exchange and pay only on a CPC (cost per click) basis, where the advertiser pays only when an ad is clicked on; a CPL (cost per lead) basis, where an advertiser pays only when a lead is gotten; or on a CPA (cost per acquisition) basis where an advertiser pays only when a sale is generated. Since publishers are almost always paid on a CPM by the member, the member assumes the risk of number of sales, leads, or clicks, not being sufficient to make a profit.

A shrewd broker may be willing to sell an advertiser this “insurance policy” thus distributing his risk to the member. The member may accept payment on a $25.00 CPA basis, for example, and show some number of ads and pay the publishers on a CPM basis. If the number of ads he shows costs less than $25.00 for every action that happens, the broker keeps the difference between the $25.00 he gets from the advertisers and whatever he had to pay the publishers. The challenge, for the broker, is to know where to run those ads and what to pay for them. If done so successfully, the member can benefit with higher than usual margins.

The novel Exchange further includes the capability to track conversions, a necessary metric for most advertisers to place bids. A conversion is when a click turns into a lead or sale. Measuring conversions is how advertisers typically gauge the performance of a campaign or strategy. A way to measure conversions is to place a small snippet of code (which includes a 1×1 pixel image) in the HTML of the “thank you” page, which the user views after placing an order, submitting contact information, or completing any other fields desired by the advertiser. When a user reaches the “thank you” page, the 1×1 pixel image is requested from the reporting server. The reporting server then checks to see if the user has clicked on the ad assigned to the related buy. If the user both clicked on the ad and visited the page that requested the 1×1 pixel image, the system counts the conversion. Thus conversions can be tracked and reported to advertisers and brokers (members). In most cases, only one conversion value can be assigned per buy; but as stated before, advertisers can create as many buys as desired.

Advertisers often want to avoid spending their entire daily budget too quickly. Metering is the process of trying to distribute spending evenly throughout the life of the buy. Three levels of metering have been developed as part of the Exchange.

A first level insures that an advertiser's budget is evenly spent. This first level of metering limits the number of times an advertiser's ad is shown in order to spread his budget evenly over time. It its most basic form, metering simply turns the bidding off and on to maintain the Exchanges default spending versus evenness ratio.

A higher, advanced level of metering gives the advertiser more control over the flow of impressions by letting him set two variables.

### EXAMPLE

An advertiser has a one day campaign with a $2,400 dollar budget. He turns on advanced metering with granularity set at one hour and a max spending cap of five times the time unit. The system will try to spend $100 per hour throughout the day. However, if in the second hour of the day the advertiser is only able to spend $40 due to market conditions, the remaining $60 will be added to the next hour's spending. If that hour falls short in spending again, the remainder will again be added to the next hour until the advertiser's accumulation reaches $500 in one hour. The spending cap will not allow the advertiser to spend more than 5 times the budget per time unit.

Another level of metering has been developed which controls the number of impressions shown by adjusting the bid: it adjusts the bid downward if too many impressions are being shown, or upward if too few are being shown. The result is that the advertiser spends a fixed amount of money over a fixed time, but may show many more impressions than with the basic or advanced metering. This highest level of metering should be used only with highly targeted campaigns, however, since lowering the bid can result is dramatically lower results.

Unique capabilities that benefit publishers have also been developed as part of the Exchange. Preferably, all publishers in the Exchange work through their member-broker, using that member's branded-version of a web-based user interface (or another interface which uses the Exchange's secure API). Through this web-based interface, the publisher is able to define each of his sites and every one of his ad spots, watch their performance in real-time, and manage his inventory, minimum pricing, and other factors for the highest revenues possible.

On the publisher side of the Exchange:
Submit any number of websites to the Exchange, describing the sites in detail, telling the system about their content and what they will and will not accept in advertising subject matter. Each new website will need to be approved by the member's administrator, however, before it can “go live” in the Exchange.
Describe each advertising spot, each place when an ad can appear, in terms of its format, acceptable content, minimum CPM payments, and other factors.
Cut and paste a short piece of ad code from the Exchange interface into his website at the spot where he wants the ad to appear. That puts the spot up for auction the next time a viewer lands on that page.
Manage which advertisers or which individual ads appear on his site—or do not appear.
   Publishers get two important advantages in working through a member of the Exchange.
First, an auction guarantees that the publisher always gets the highest price any advertiser is willing to pay at that moment for that opportunity. In a traditional fixed-rate system there is often an advertiser who would have paid more for the ad. Or in the case where no advertiser was willing to pay the fixed rate, some advertiser may have at least have been willing to pay something a little less.
Second, an auction sells off much more of the publisher's inventory, which makes him more money overall. There is no such thing as bad inventory—it is only a matter of fair pricing.

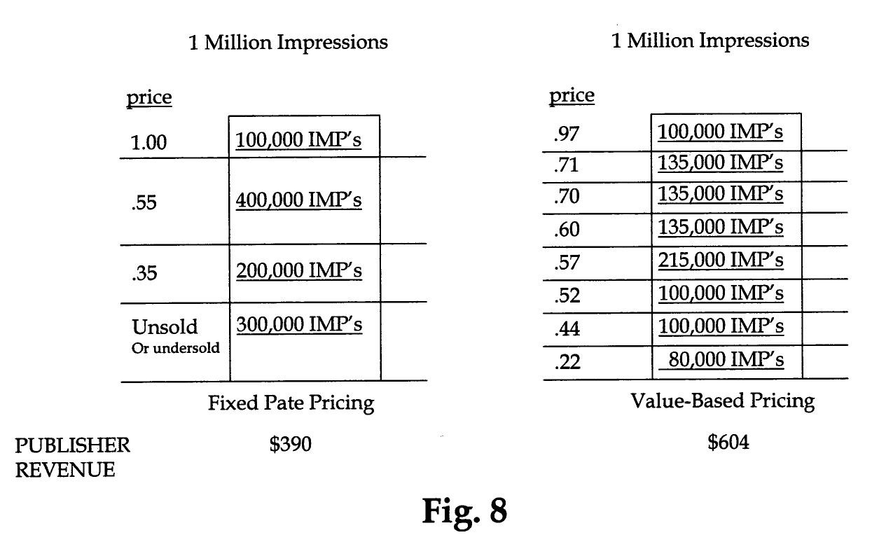

Another novel feature of the Exchange which benefits the publisher is value-based pricing, as illustrated in FIG. 8. Under any fixed-price advertising model, whether it is on the web or in print, television or radio, there are frequently advertisers who would pay more than published rates if they could know more about the opportunity; that is, if they could be assured of targeting their exact audience. Conversely, even when the published rates are higher than most advertisers are willing to pay to reach the audience, there are likely some advertisers who would pay some price to reach that audience.

As shown in FIG. 8, in the auction-based exchange, every ad opportunity is available for auction to all advertisers in the Exchange. Consequently, with advanced targeting and value pricing selected by the advertisers, and with the inherent knowledge base of the characteristics of the ad opportunity, the exchange will sell every ad for the highest price any advertiser is willing to pay. That is value pricing for the highest price.

Moreover a publisher sells more of his inventory than he would under any fixed rate scheme. With fixed-rates, the publisher can usually sell off a lot of his premium inventory. But how does he price the remainder? Usually he does not want the buyers of his premium inventory to see low pricing on his remainder, so he offloads it to another seller, or it goes unsold completely. An advertiser who was willing to pay $1.00 CPM to show an ad to a viewer the first three times may not want to show that same ad to that same viewer another three times for $1.00—but he might for $0.50, or $0.25. Or a large ad campaign running on the publisher's site simply ran out of budget—how does the publisher sell off the next few thousand impressions before another campaign gets underway? The auction-based model gets the publisher the highest price any advertiser is willing to pay—whatever that price may be—on all of his inventory. This effect is clearly illustrated by comparing the fixed price model on the left with the value based model on the right.

Another novel feature is that publishers working through an Exchange member have almost no risk. Here is how:
The publisher sets a minimum price he is willing to accept for a specific spot. For example, if the advertiser knows he can get $0.25 CPM from some non-member network, he specifies that as the minimum.
Someone on behalf of the publisher then enters pass through ad code from another network, broker or other source as the backup ad source if the minimum price is not met in an auction. When a viewer lands on that page, the Exchange runs the auction for each impression on each spot. If an advertiser meets or beats the publisher's minimum, the Exchange shows that advertiser's ad. If no advertiser offers a bid that results in a publisher payment equal to or above the publisher's minimum, The Exchange shows the pass through ad indicated by the publisher.

In the first instance the publisher made more than he would have from the other source; in the second instance he lost nothing for trying.

The forgoing discloses how to create a novel Internet Advertising exchange system, and various novel features that are of particular utility. The implementation of this system may be accomplished in a variety of ways that those skilled in the art will appreciate. Therefore the implementation details are not considered part of the novelty or unique to the operation of the system as disclosed.

We claim:

1. An internet advertising process for connecting advertisers with publishers who offer advertisement spots on Internet sites, and brokers, who represent advertisers and publishers, comprising; running a real-timed auction on the Exchange when a publisher's site is accessed by a user, wherein, Advertisers specify their bids and targets to exchange, via the broker, in advance. determining if the ad available and the user are appropriately matched with the bids offered and targets specified.

2. The process of claim 1 further comprising;
placing advertisements in spots on the accessed site according to the highest bids received from the brokers or if no broker supplied bid equals a known price previously agreed to from another source for a particular spot, placing the ad from the other source.

3. The process of claim 1 wherein advertiser strategy to determine bid price is potentially based on general or detailed information about the user and publisher site, provided to the broker by the exchange at the time the site is accessed.

4. The process of claim 3 wherein the information includes one or more of;
frequency caps,
user timezone,
specific timezone,
country, State, DMA,
site content ratings,
site animation,
site format,
other site specific data,
user browser type,
user operating system; or,
ad type.

5. The process of claim 1 wherein the auction is held within 100 msec.

6. The process of claim 1 wherein the Exchange supports brokers accepting advertiser payments and paying publishers based on differing valuation bases.

7. The process of claim 6 wherein the valuation bases supported by the Exchange include;
CPM (cost per thousand),
CPC (cost per click),
CPL (cost per lead); or
CPA (cost per action).
